(19) United States
(12) Patent Application Publication
(10) Pub. No.: US 2009/0241198 A1
(43) Pub. Date: Sep. 24, 2009

(54) INAPPROPRIATE CONTENT DETERMINATION APPARATUS, CONTENT PROVISION SYSTEM, INAPPROPRIATE CONTENT DETERMINATION METHOD, AND COMPUTER PROGRAM

(75) Inventors: Tomohiro Takagi, Kagawa (JP); Hitoshi Kamura, Kagawa (JP)

Correspondence Address: STAAS & HALSEY LLP, SUITE 700, 1201 NEW YORK AVENUE, N.W., WASHINGTON, DC, 20005, US

(73) Assignee: FUJITSU SHIKOKU SYSTEMS LIMITED, Kagawa (JP)

(21) Appl. No.: 12/327,669

(22) Filed: Dec. 3, 2008

(30) Foreign Application Priority Data
Mar. 18, 2008 (JP) JP2008-070034

(51) Int. Cl. G06F 21/00

(52) U.S. Cl. 726/26

(57) ABSTRACT

An SNS system 1 is provided with: an inappropriateness questioning pattern storage unit that stores an inappropriate upload pattern that is a pattern of a trend seen when multiple pieces of inappropriate content are uploaded; and a post pattern evaluation unit and overall evaluation unit that determine whether or not the content is inappropriate by checking whether or not the inappropriate upload pattern stored in the inappropriateness questioning pattern storage unit is seen when the multiple pieces of content are uploaded.

### BACKGROUND OF THE INVENTION

1. Field of the Invention

The embodiments discussed herein are directed to a system, a method, and so on for handling content that has been uploaded or the like to a communication means such as an SNS.

2. Description of the Related Art

It has recently become both cheap and easy to connect a personal computer to a network such as the Internet. Furthermore, mobile telephone terminals have seen both improvements in functionality and advancements in applications, and it has become easy to connect mobile telephone terminals to the Internet as well.

As a result, many users are becoming able to communicate with one another via a network such as the Internet. While the electronic bulletin board is well-known as a communication service, SNSs (Social Networking Services) have also become known as communication services.

These services have a benefit that users can freely exchange opinions with one another. However, these services also have a downside in that it is easy to make posts (statements) with content that attacks or “flames” other users, content that offends other users, content regarding private details of individuals (so-called “personal information”), and details of no relation to the topic at hand. Such posts disrupt the order of communication, and may lead to a drop in the quality of the service. It takes an inordinate amount of time and energy for an administrator to check all the details of every post, and doing so also increases labor costs.

Conventionally, there is a method for solving such problems. According to this method, the details of posts are analyzed using a language analysis process that analyses words and phrases, and unacceptable content is then removed.

However, language analysis has the following problems. First, even assuming that place names can be detected, it is difficult for language analysis to determine whether or not that place name is a private detail of an individual (for example, an individual's address) or whether it is commonly-known information (for example, the address of a shop or a public facility). When part of a character string is concealed (that is, when substitute symbols are included), there are cases where analysis cannot be properly carried out.

### SUMMARY

It is a first aspect of the embodiments discussed herein to provide an inappropriate content determination apparatus including an inappropriate upload pattern storage portion that stores an inappropriate upload pattern that is a pattern of a trend seen when multiple pieces of inappropriate content are uploaded, and an inappropriateness determination portion that determines whether or not multiple pieces of content are inappropriate by checking whether or not the inappropriate upload pattern stored in the inappropriate upload pattern storage portion is seen when the multiple pieces of content are uploaded.

According to the first aspect of the embodiments discussed herein, it is possible to determine whether or not content is inappropriate based on the method in which that content was posted, thus making it possible to make the determination regardless of the accuracy of language analysis performed on the posted content.

It is a second aspect of the embodiments discussed herein to provide an inappropriate content determination apparatus including an inappropriate personal pattern storage portion that stores an inappropriate personal pattern that is a pattern of a trend seen in a person who uploads inappropriate content, and an inappropriateness determination portion that determines whether or not content uploaded by a user is inappropriate by checking whether or not a pattern of a trend seen in the user corresponds to the inappropriate personal pattern stored in the inappropriate personal pattern storage portion.

According to the second aspect of the embodiments discussed herein, it is possible to determine whether or not content is inappropriate based on personal patterns of the member that made the post, thus making it possible to make the determination regardless of the accuracy of language analysis performed on the posted content.

It is a third aspect of the embodiments discussed herein to provide a content provision system for providing first content that is content uploaded by a first user via a network to a second user via the network. The content provision system includes an inappropriate upload pattern storage portion that stores an inappropriate upload pattern that is a pattern of a trend seen when multiple pieces of inappropriate content are uploaded, an inappropriateness score allocation portion that gives multiple pieces of the first content a predetermined number of points as an inappropriateness score that is a score indicating likelihood that the multiple pieces of the first content are inappropriate, in the case where the inappropriate upload pattern stored in the inappropriate upload pattern storage portion is seen when the multiple pieces of the first content are uploaded, and a content provision portion that provides a piece of the first content to the second user where the inappropriateness score of the piece of the first content is less than a predetermined score, and does not provide the piece of the first content to the second user where the inappropriateness score of the piece of the first content is greater than the predetermined score.

According to the third aspect of the embodiments discussed herein, it is possible to alter weighting on the changes in the usage states of members, uploading patterns of members during events/holidays, and so on, even if the uploads have the same behavioral patterns, and increase the determination accuracy, by adjusting an inappropriateness score.

Preferably, the inappropriate upload pattern may be a pattern in which an identical person uploads no less than a predetermined number of pieces of content during an interval that is no greater than a predetermined amount of time. Further, the inappropriate upload pattern may be a pattern in which an identical person uploads no less than two identical or similar pieces of content in succession.

According to fourth and fifth aspects of the embodiments discussed herein, it is possible to effectively determine post flooding, which is a representative example of inappropriate content.

It is a sixth aspect of the embodiments discussed herein to provide a content provision system for providing first content that is content uploaded by a first user via a network to a second user via the network. The content provision system includes an inappropriate personal pattern storage portion that stores an inappropriate personal pattern that is a pattern of a trend seen in a person who uploads inappropriate content, an inappropriateness score allocation portion that gives the first content a predetermined number of points as an inappropriateness score that is a score indicating likelihood that the first content is inappropriate where a pattern of a trend seen in the first user corresponds to the inappropriate personal pattern stored in the inappropriate personal pattern storage portion, and a content provision portion that provides the first content to the second user where the inappropriateness score of the first content is less than a predetermined score, and does not provide the first content to the second user where the inappropriateness score of the first content is greater than the predetermined score.

According to the sixth aspect of the embodiments discussed herein, it is possible to alter weighting even on members who have the same personal patterns based on usage states, identity confirmation status, and so on, and increase the determination accuracy, by adjusting an inappropriateness score.

Preferably, the inappropriate personal pattern may be a pattern regarding at least two of the following items: a ratio of registered profile items to a total number of profile items; a number of second users that are friends; a type of issuer of an email address used; and an amount of time that has passed since use of the content provision system commenced.

According to a seventh aspect of the embodiments discussed herein, it is possible to effectively carry out a determination by verifying typical personal patterns that indicate that inappropriate content will be posted.

According to other aspects of the embodiments discussed herein, methods, apparatuses, circuits, systems, computer programs, recording media, data structures, and so on to which the individual constituent elements or an arbitrary combination of the constituent elements of the inappropriate content determination apparatus and content provision system disclosed in the present application are applied are also effective.

### BRIEF DESCRIPTION OF THE DRAWINGS

FIG. 1 illustrates an example of a network system including an SNS system and terminal apparatuses.

FIG. 2 illustrates an example of the hardware configuration of an SNS system.

FIG. 3 illustrates an example of the functional configuration of an SNS system.

FIG. 4 illustrates an example of post log data.

FIG. 5 illustrates an example of profiling pattern data.

FIG. 6 illustrates an example of member characteristic data.

FIG. 7 illustrates an example of a storage format for first evaluation points in a member-by-member evaluation point storage unit.

FIG. 8 illustrates an example of the flow of an article pattern evaluation process.

FIG. 9 illustrates an example of retrieved post log data.

FIG. 10 illustrates an example of the flow of an overall process.

FIG. 11 illustrates an example of the flow of the overall processing performed by an SNS system.

FIG. 12 illustrates a variation on the functional configuration of an SNS system.

FIG. 13 illustrates an example of a storage format for evaluation correction points in a correction point definition storage unit.

FIG. 14 illustrates an example of the transition of evaluation correction points of members.

FIG. 15 illustrates an example of the correction of an evaluation score.

### DESCRIPTION OF THE PREFERRED EMBODIMENTS

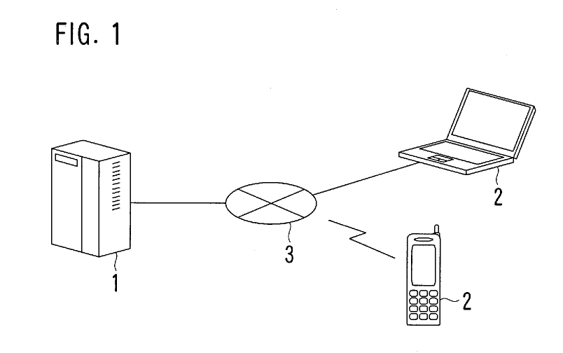

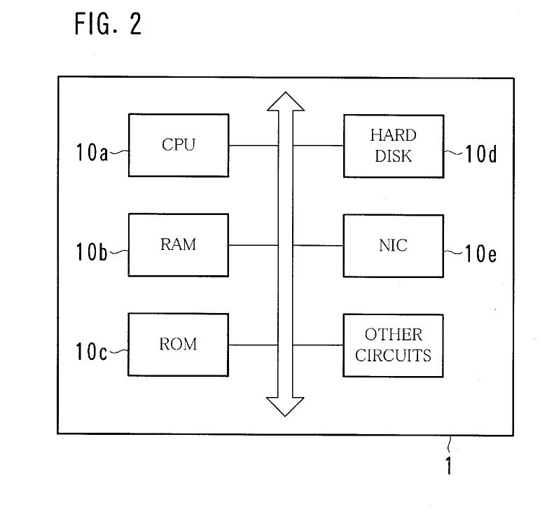

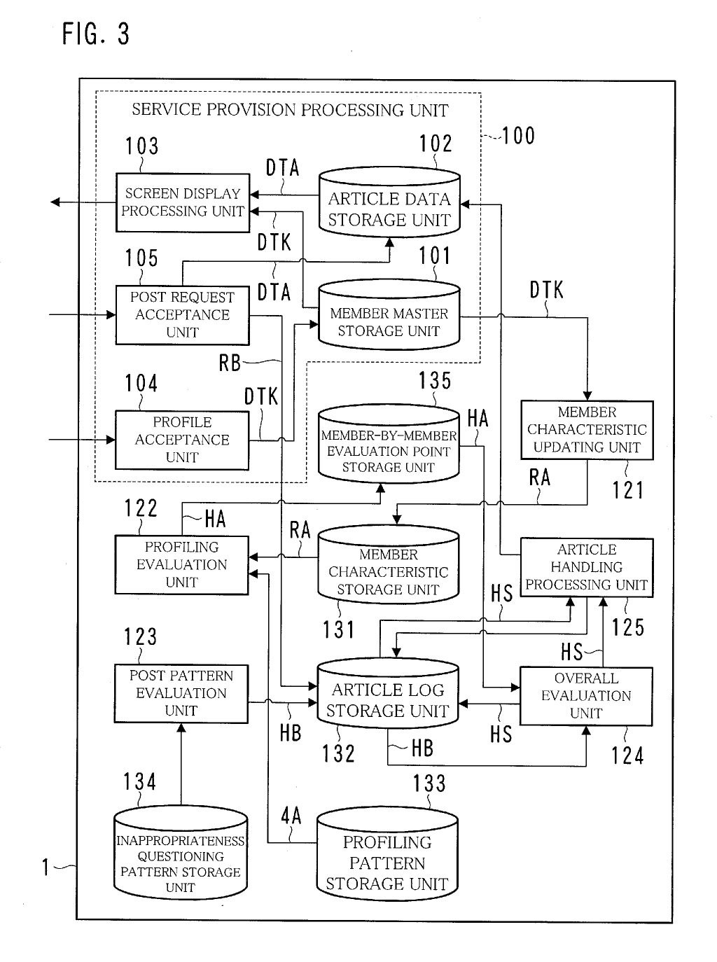

FIG. 1 illustrates an example of a network system including an SNS system 1 and terminal apparatuses 2; FIG. 2 illustrates an example of the hardware configuration of the SNS system 1; and FIG. 3 illustrates an example of the functional configuration of the SNS system 1.

In FIG. 1, the SNS system 1 is a system by which a distributor provides SNS (Social Networking Service) services, such as, for example, messaging, diaries, communities, and friends to users.

The SNS system 1 and each terminal apparatus 2 are capable of connecting to each other via a network such as the Internet.

As shown in FIG. 2, the SNS system 1 is configured of a CPU 10a, a RAM 10b, a ROM 10c, a hard disk 10d, a NIC 10e, and other various types of hardware.

Programs and data for implementing the functions of the following units, shown in FIG. 3, may be stored in the ROM 10c or the hard disk 10d. These units include a service provision processing unit 100, a member characteristic updating unit 121, a profiling evaluation unit 122, a post pattern evaluation unit 123, an overall evaluation unit 124, an article handling processing unit 125, a member characteristic storage unit 131, an article log storage unit 132, a profiling pattern storage unit 133, an inappropriateness questioning pattern storage unit 134, a member-by-member evaluation point storage unit 135, and so on. These programs and data are loaded into the RAM 10b and executed by the CPU 10a as necessary.

A workstation, a server device, or the like is used as the SNS system 1. The SNS system 1 can also be configured with the various units shown in FIG. 3 being spread out across multiple devices.

The terminal apparatus 2 is a client by which a user uses the SNS. The terminal apparatus 2 is provided with a function for connecting to the Internet, a web browser, and an email client. A personal computer, mobile telephone terminal, or the like can be used as the terminal apparatus 2.

A single member ID may be allocated to each user, or member, of the service (hereinafter referred to simple as a “member”).

Next, the functions of the various units in the SNS system 1 shall be described, the descriptions being broadly divided between an overall process for providing a service and a process for hiding an article thought to be inappropriate.

### [Overall Process for Providing a Service]

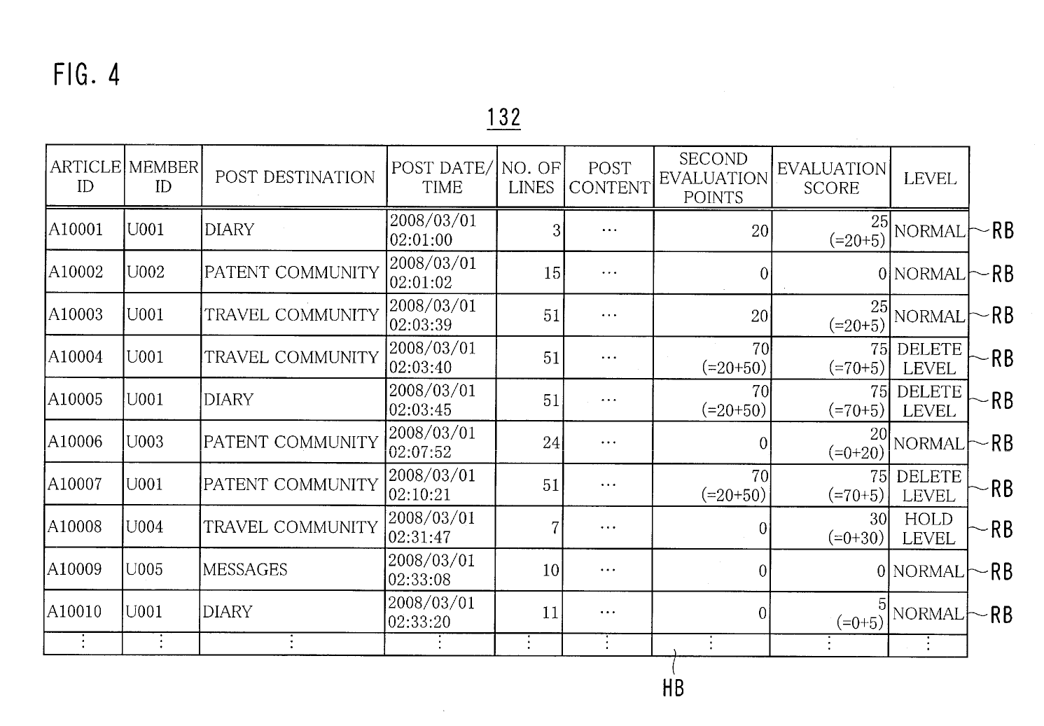

FIG. 4 illustrates an example of post log data RB.

The service provision processing unit 100 is configured primarily of a member master storage unit 101, an article data storage unit 102, a screen display processing unit 103, a profile acceptance unit 104, and a post request acceptance unit 105, and performs processing for providing an SNS service in basically the same manner as is conventionally performed.

The screen display processing unit 103 performs processing for causing a terminal apparatus 2 to display screens such as those mentioned hereinafter: a screen for performing signup procedures; a screen for a member to input or modify his/her own profile; a screen for establishing or managing a community; a screen for managing one's own diary; a screen for posting an article to one's own or another member's diary; a screen for writing a message and sending the message to another member; a screen for posting an article to a community; a screen for adding another member to one's friends; a screen for removing another member from one's friends; a screen for viewing or managing messages sent to oneself; a screen for viewing one's own or another member's diary articles; a screen for viewing community articles; and so on. To be more specific, screen data for displaying the screens (for example, HTML files, GIF files, and so on) is sent to a terminal apparatus 2 in response to a request from that terminal apparatus 2. Member master data DTK and article master data DTA, described later, are used as appropriate at this time.

Hereinafter, messages, community articles, and diary articles shall be collectively referred to as “articles”. Furthermore, writing a message (article) and sending that message to another member, posting an article to a community, and posting a diary article shall be collectively referred to as “an article post”, “posting an article”, or the like. Note that the posting of an article is carried out by uploading text data, image data, or the like constituting the article from a terminal apparatus 2 to the SNS system 1.

However, as opposed to the conventional procedure, the screen display processing unit 103 excludes articles for which the “level” field in the post log data RB (mentioned later) is “hold level” or “delete level”. In other words, articles having such post log data RB are treated as being hidden. The post log data RB shall be described later in due order.

The member master data DTK is stored (registered) on a member-by-member basis in the member master storage unit 101. The member ID, name, nickname, age, day joined (date of membership), email address, profile, and member IDs for other members that are friends, are so on are indicated in the member master data DTK. Information on items such as the member's sex, address, workplace, birthday, blood type, interests, and so on is included in the profile.

As per the conventional technique, the profile acceptance unit 104 accepts information on a profile inputted or modified by the member or information on friend relationships specified or modified by the member that has been sent from the terminal apparatus 2. The details of the member master data DTK for that member are updated based on that information.

As per the conventional technique, the post request acceptance unit 105 accepts data indicating the details of an article requested by the member to be posted and the posting destination that has been sent from the terminal apparatus 2. A unique article ID is then issued for that article; article master data DTA indicating the details of the article and the issued article ID is generated; and the generated data is stored in a region within the article data storage unit 102 (for example, a directory) corresponding to the posting destination. Through this, the posting (uploading) of an article is completed.

Furthermore, in addition to this conventional processing, the post request acceptance unit 105 generates the post log data RB indicating the article ID of the article, the member ID of the member that requested the post (that is, carried out the post), the posting destination, the date and time of the post, the number of lines, the details (post details), and so on each time the posting of an article is completed, and causes the generated data to be stored in the article log storage unit 132. In this manner, the post log data RB is stored in the article log storage unit 132, as shown in FIG. 4. In addition to the above, the post log data RB includes a second evaluation points field, an evaluation score field, and a level field. The initial settings for these fields are “null”. The meanings of “second evaluation points” and so on shall be provided later.

### [Processing for Hiding Articles Thought to be Inappropriate]

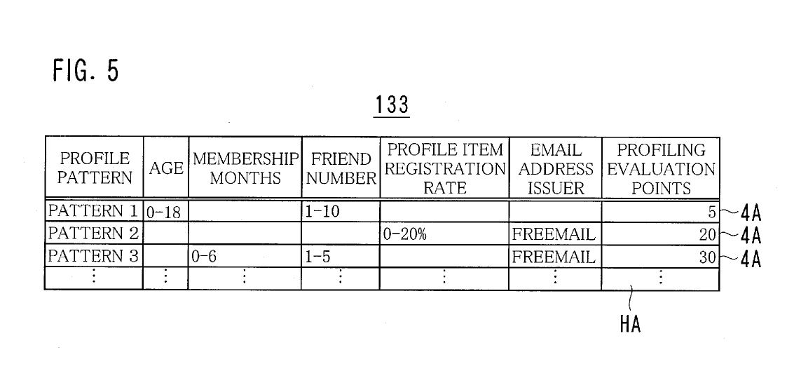

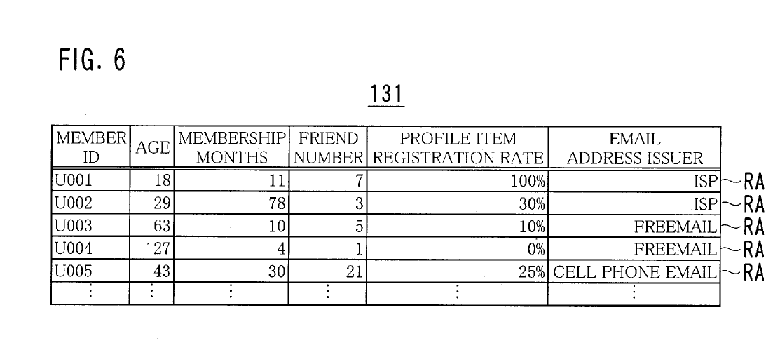

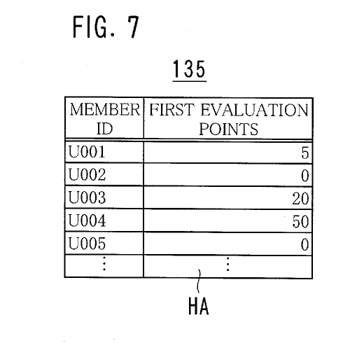

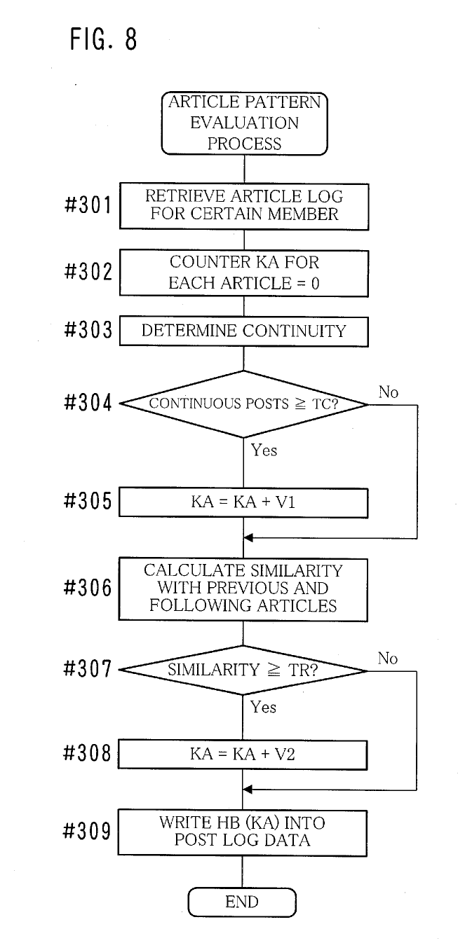

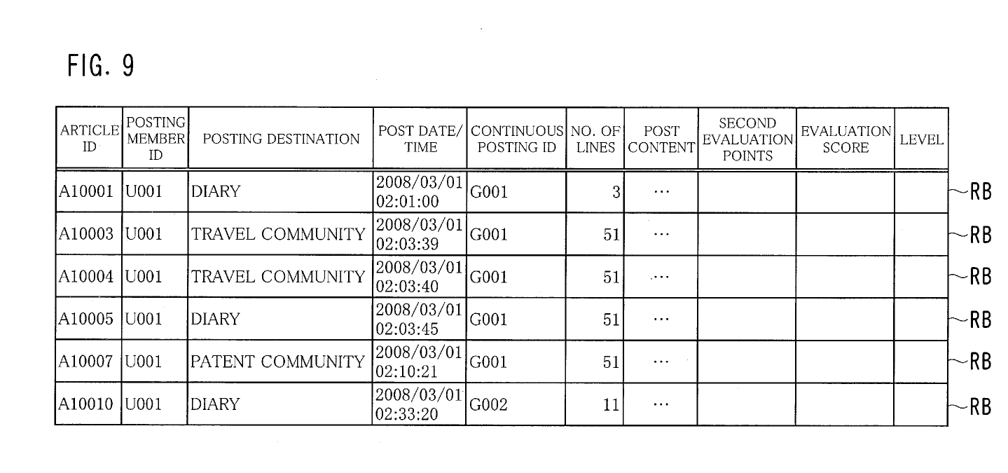

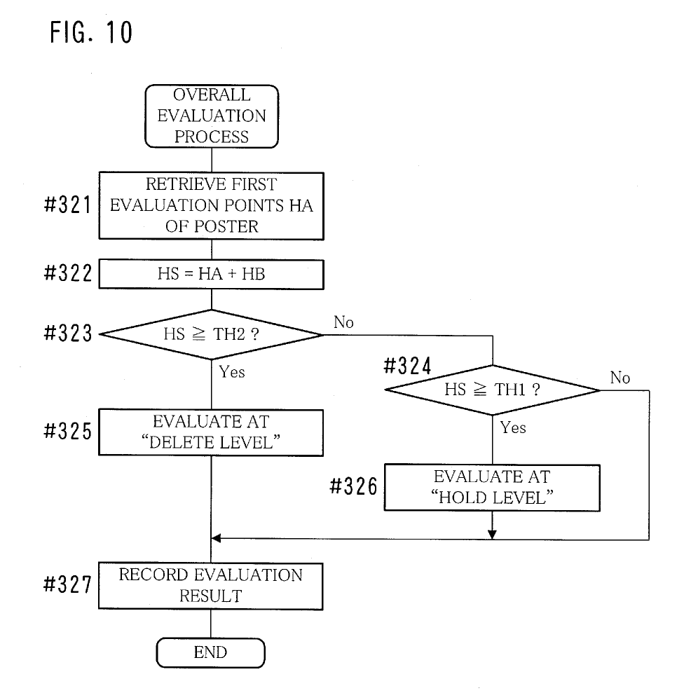

FIG. 5 illustrates an example of profiling pattern data 4A; FIG. 6 illustrates an example of member characteristic data RA; FIG. 7 illustrates an example of a storage format for first evaluation points HA in the member-by-member evaluation point storage unit 135; FIG. 8 illustrates an example of the flow of an article pattern evaluation process; FIG. 9 illustrates an example of retrieved post log data RB; and FIG. 10 illustrates an example of the flow of an overall process.

The SNS system 1 calculates a score called an “evaluation score HS”, which expresses how likely it is that an article is inappropriate. The higher the evaluation score HS is, the more likely it is that the article is inappropriate.

The SNS system 1 determines that an article is of a level of inappropriateness that requires the publication of that article to be temporarily stopped (held) and the article to be examined by an administrator in the case where the evaluation score HS of the article is greater than or equal to a threshold TH1 (for example, “30”) and is less than a threshold TH2 (for example, “50”). This level shall be called a “hold level” hereinafter. Meanwhile, the SNS system 1 determines that an article is of a level of inappropriateness that requires the article to be hidden and deleted immediately without being examined by an administrator in the case where the evaluation score HS of the article is greater than or equal to the threshold TH2. This level shall be called a “delete level” hereinafter.

Incidentally, certain patterns (regularities) can generally be seen in members who post inappropriate articles. These patterns can be derived by profiling (analyzing) members who have posted inappropriate articles in the past. The patterns can also be predicted.

Data indicating what pattern characteristics are present for members for whom trends toward posting inappropriate articles are frequently seen or can be predicted is stored in the profiling pattern storage unit 133 shown in FIG. 3.

To be more specific, as shown in FIG. 5, profiling pattern data 4A, indicating a score (profiling evaluation points) expressing the likelihood (a tendency) that a member will post inappropriate articles, is stored for each pattern using a single item or a combination of the items listed as follows. These items include the member's age, how many months have passed since the member joined (membership months), the number of friends, the ratio of items registered (that is, not left blank) to the total items in the profile (profile item registration rate), and the type of issuer of the email address used by the member for the SNS service (email address issuer).

Furthermore, generally speaking, there are cases where multiple articles having the same or similar details are posted. The details of such articles are generally more likely than other articles to violate membership rules. For example, such articles are likely to be articles advertising the sale of illegal products, articles advertising web sites that go against public decency, articles featuring unfounded rumors, and so on. That trend is even greater when the degree of similarity is greater than or equal to a certain amount. Such articles are often posted repeatedly by the same person over a short period of time.

A reference value for how high the degree of similarity between multiple articles must be before those articles are considered likely to be inappropriate, or in other words, a reference value for a degree of similarity thought to indicate that articles are inappropriate, is stored in the inappropriateness questioning pattern storage unit 134. This value shall be called a “similarity threshold TR” hereinafter.

Furthermore, a reference value for how many articles must be posted by the same person prior to an interval greater than or equal to a predetermined time T1 before those articles are considered likely to be inappropriate, or in other words, a reference value for the number of consecutive posts thought to indicate that articles are inappropriate, is stored in the inappropriateness questioning pattern storage unit 134. This value shall be called a “continuity threshold TC” hereinafter.

As shown in FIG. 6, the member characteristic data RA, indicating characteristics such as the age, membership months, number of friends (friend number), profile item registration rate, email address issuer, and so on are stored, on a member-by-member basis, in the member characteristic storage unit 131.

Each time a new member joins the service, member characteristic data RA is generated for that member, and the generated data is stored in the member characteristic storage unit 131. However, at this point in time, nothing is present in the member characteristic data RA of that member aside from the member ID (the member ID of that member him/herself), the email address issuer, and the membership months (here, “0 months”). Note that the email address issuer can be determined based on the domain name of the email address specified by the member during the membership procedures.

After this, when the member inputs or modifies his/her age or profile, increases or decreases his/her friends, and so on, or in other words, when the member master data DTK of that member stored in the member master storage unit 101 is updated, the member characteristic data RA of that member is updated in accordance therewith. The process for updating the member characteristic data RA is carried out by the member characteristic updating unit 121 in the following manner.

The member characteristic updating unit 121 continuously monitors the update of the details of the member master data DTK. Upon detecting that the member master data DTK of a certain member is updated, the member characteristic updating unit 121 calls that member master data DTK.

The age indicated in the called member master data DTK is then written into the “age” field of the member characteristic data RA of that member (in other words, the member characteristic data RA that has the same member ID as the member ID indicated in the member master data DTK). Then, the number of member IDs of friends indicated in the member master data DTK is counted, and that number is then written into the “friend number” field in the member characteristic data RA. Furthermore, the number of items that have been registered in the profile indicated in the member master data DTK is then counted. The ratio of that number to the total number of items in the profile is then calculated and written into the “profile item registration rate” field in the member characteristic data RA. Through this, the updating of the member characteristic data RA is completed.

The member characteristic updating unit 121 updates the member characteristic data RA each time it detects that the details of the member master data DTK to which the member characteristic data RA corresponds have been updated.

Furthermore, the member characteristic updating unit 121 updates the “membership months” in the member characteristic data RA as necessary every predetermined time (for example, midnight) each day. To be more specific, the member characteristic updating unit 121 refers to the membership date in the member master data DTK, and recalculates the number of months that have passed since membership. In the case where the number of months has increased, the “membership months” is overwritten with the re-calculated number of months. This updating process is carried out for all instances of member characteristic data RA.

As described earlier with reference to FIG. 4, the post log data RB is stored in the article log storage unit 132 for each posted article.

Each time the member characteristic data RA stored in the member characteristic storage unit 131 is updated, the profiling evaluation unit 122 finds, through the following method, points expressing how likely it is that the member indicated in that member characteristic data RA will post an inappropriate article (called “first evaluation points HA” hereinafter).

It is then checked whether or not the age, membership months, friend number, profile item registration rate, and email address issuer indicated in the member characteristic data RA all correspond to the age, membership months, friend number, profile item registration rate, and email address issuer indicated in any of the instances of profiling pattern data 4A (see FIG. 5) stored in the profiling pattern storage unit 133.

However, in the case where there is a blank item in the profiling pattern data 4A, that item is excluded from the checking. For example, in the case where it is checked whether or not the details indicated in the post log data RB correspond to the details indicated in the profiling pattern data 4A for “pattern 1”, only the age and friend number items are checked.

In the case where the items correspond to those of one of the instances of profiling pattern data 4A, the profiling evaluation points indicated in the profiling pattern data 4A are taken as the first evaluation points HA of that member. Note that in the case where items correspond to those in multiple instances of profiling pattern data 4A, a total of the profiling evaluation points indicated in each instance may be taken as the first evaluation points HA, or the highest instance of profiling evaluation points may be taken as the first evaluation points HA.

The first evaluation points HA of each member are stored in the member-by-member evaluation point storage unit 135 in association with the member IDs of those members, as shown in FIG. 7. Each time the first evaluation points HA of a member are found by the profiling evaluation unit 122, the first evaluation points HA of that member stored in the member-by-member evaluation point storage unit 135 are updated.

The post pattern evaluation unit 123 calculates the likelihood that a posted article is inappropriate (evaluates the article) based on patterns with respect to the previous or following articles. Here, the procedure for the processing performed by the post pattern evaluation unit 123 shall be described with reference to the flowchart in FIG. 8 and so on.

The post pattern evaluation unit 123 first retrieves the post log data RB of an article posted by the same member, or in other words, post log data RB indicating the same member ID, from the article log storage unit 132 (#301 in FIG. 8). For example, when the post log data RB indicating the member ID “U001” is retrieved, results such as those shown in FIG. 7 are obtained.

A counter KA is provided to each article posted by the member (#302). The initial value of each counter KA is “0”.

The determination of the continuity of the articles posted by the member is carried out as follows (#303). The time difference (interval) between the post dates of two temporally adjacent articles is first calculated. Single or multiple articles are grouped together using a space between articles in which the interval is greater than or equal to a predetermined time T1 as a partition.

For example, in the case where the predetermined time T1 is “10 minutes”, the space between the articles with articles IDs of “A10007” and “A10010” is taken as the partition, resulting in the five articles “A10001”, “A10003”, “A10004”, “A10005”, and “A10007” being grouped into one group and the one article “A10010” being grouped into another group. In other words, the post pattern evaluation unit 123 assumes that the former five articles were consecutively posted.

In the case where the number of members (articles) in the group, or in other words, the number of consecutive posts, is greater than or equal to the continuity threshold TC (Yes in #304), inappropriate questioning points V1, which are a predetermined value (for example, “20”), are added to the counters KA of the articles in the group (#305). For example, if the continuity threshold TC is “3”, “20” is added to each of the counters KA for the five abovementioned articles.

The similarity (likeness, degree of similarity) between the details of two temporally adjacent articles is then calculated (#306). The calculation of the similarity can be carried out using a publicly-known method. For example, the method using a Levenshtein distance, as disclosed in Public Document 1 (JP 2007-310746A), can be used. Alternatively, the Iihashi method, as disclosed in Public Documents 2 (“Promoting ‘Similarities in Text and the Iihashi Method’, 16th University Education for the Next Generation ‘Cultivating Knowledge’ (Tokyo)—Sensitive Research Lifestyle (25)”, found through Internet search on Mar. 5, 2008, at http://shyosei.cocolog-nifty.com/shyoseilog/2007/08/1625_{—}2f2e.html) and 3 (“Second-type Character String Similarity Level Based On Appearance Frequency of Characters”, Iihashi, Yasuhiro, found through Internet search on Mar. 5, 2008, at http://www.sciencehouse.jp/etc/research/20070807.pdf), may be used.

Methods disclosed in other public documents may be used as well.

The post pattern evaluation unit 123 adds inappropriate questioning points V2, which are a predetermined value (for example, “50”), to the counters KA of articles whose similarity to a previous or following article is greater than or equal to the similarity threshold TR (for example, “80%”) (Yes in #307, #308).

The point numbers indicated by the counters KA at this point in time express the likelihood that each article is inappropriate. Hereinafter, the point numbers found in this manner shall be called “second evaluation points HB”. The post pattern evaluation unit 123 writes the second evaluation points HB for each article into the “second evaluation points” field in the post log data RB for each article stored in the article log storage unit 132 (#309).

Returning to FIG. 3, the overall evaluation unit 124 performs an overall evaluation of the likelihood that a posted article is inappropriate using a method such as that illustrated in the flowchart shown in FIG. 10.

First, the first evaluation points HA (see FIG. 7) of the member that posted the article that is to be evaluated is retrieved from the member-by-member evaluation point storage unit 135 (#321 in FIG. 10). The evaluation score HS is calculated by adding the retrieved first evaluation points HA to the second evaluation points HB indicated in the post log data RB of that article (#322).

In the case where the evaluation score HS is greater than or equal to the threshold TH2 (Yes in #323), that article is evaluated as being at the delete level (#325). Meanwhile, in the case where the evaluation score HS is greater than or equal to the threshold TH1 but less than the threshold TH2 (No in #323; Yes in #324), that article is evaluated as being at the hold level (#326).

Next, the calculated evaluation score HS and the evaluated level are written into the “evaluation score” and “level” fields of the post log data RB (#327). In the case where the evaluation resulted in neither the hold level nor the delete level, “normal”, indicating that the article is not inappropriate, is written into the “level” field.

Note that as described above, articles evaluated (determined) to be at the hold level or the delete level are hidden.

Returning to FIG. 3, the article handling processing unit 125 handles the data of articles determined by the overall evaluation unit 124 to be at the hold level or the delete level in the following manner.

With respect to an article determined to be at the delete level, the article handling processing unit 125 deletes the article master data DTA of the article from the article data storage unit 102 and deletes the post log data RB of that article from the article log storage unit 132. The timing of this deletion may be immediately after the evaluation by the overall evaluation unit 124, or may be at a predetermined time (for example, at the top of every hour).

However, with respect to an article determined to be at the hold level, the article handling processing unit 125 first checks with an administrator, using email or the like, as to whether or not it is acceptable to delete the article. At that time, data indicating the details of the article is sent to the administrator. The administrator examines the article, decides whether or not to delete the article, and responds via email or the like.

In the case where the article handling processing unit 125 receives a response indicating that the article is to be deleted, it deletes the article master data DTA of that article from the article data storage unit 102 and deletes the post log data RB of that article from the article log storage unit 132. However, in the case where the article handling processing unit 125 receives a response indicating that the article is not to be deleted, it updates the “level” in the post log data RB of that article to “normal”.

It should be noted that post log data RB for which the “level” is “normal” is quickly deleted from the article log storage unit 132 after the evaluation. This data may alternatively be deleted at a predetermined time.

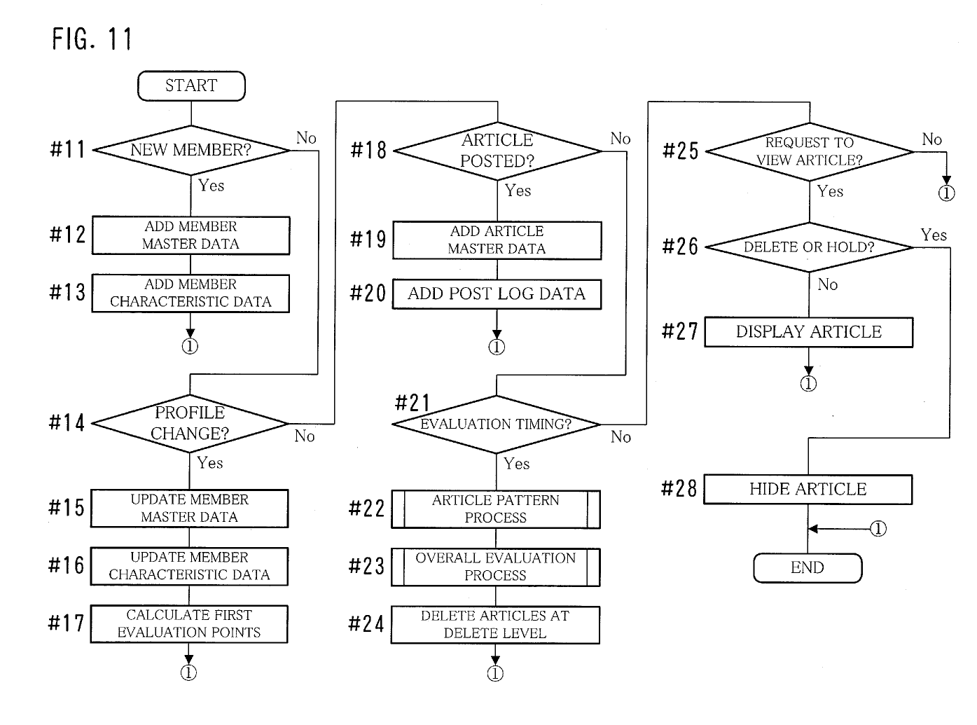

FIG. 11 illustrates an example of the flow of the overall processing performed by the SNS system 1.

Next, the flow of the overall processing particularly for hiding an inappropriate article performed by the SNS system 1 shall be described with reference to the flowchart in FIG. 11.

Each time an event occurs, the SNS system 1 executes the following processes in accordance with that event.

Upon receiving data for registration procedures performed by a new member (Yes in #11), the SNS system 1 generates and stores member master data DTK for that member (#12), and generates and stores member characteristic data RA (see FIG. 6) for that member as well (#13).

Moreover, upon receiving data indicating a change in a member's profile or friend relationships (Yes in #14), the SNS system 1 updates the member master data DTK of that member in accordance with the received data (#15). Furthermore, the member characteristic data RA of that member is updated in accordance with the update to the member master data DTK (#16). Further still, the first evaluation points HA for that member is calculated (or re-calculated) in accordance with the update to the member characteristic data RA (#17). Similarly, in the case where the membership months of the member have increased due to the passage of time, the member characteristic data RA of that member is updated (#16), and the first evaluation points HA for that member are recalculated (#17).

Moreover, upon receiving the details of a new article and posting destination data (Yes in #18), the SNS system 1 generates and stores article master data DTA for that article (#19), and generates and stores post log data RB for that article as well (#20).

Moreover, when the timing at which an article is to be evaluated is reached (Yes in #21), the SNS system 1 evaluates the articles written by the respective members based on posting patterns (#22). The evaluation method is the same as that described earlier in FIG. 8. Furthermore, an overall evaluation is carried out, by, for example, adding the evaluation of the member who posted the article him/herself (#23). The overall evaluation method is the same as that described earlier in FIG. 10. The data of articles that have been evaluated to be at the delete level is deleted at an appropriate timing (#24). With regards to articles that have been evaluated to be at the hold level, the handling thereof is checked with an administrator. In the case where a response indicating the article is to be deleted has been obtained, the article is re-evaluated to be at the delete level, and the data of that article is deleted. However, in the case where a response indicating the article is not to be deleted has been obtained, the article is handled as a non-inappropriate (that is, a normal) article.

Moreover, upon receiving a request for viewing an article from a terminal apparatus 2 (Yes in #25), the SNS system 1 causes that article to be displayed in the terminal apparatus 2 (#27) in the case where the level of the article is neither the delete level nor the hold level (No in #26). In the case where the level of the article is the delete level or the hold level (Yes in #26), the article is not displayed in the terminal apparatus 2 by, for example, rejecting the request (#28).

According to the present embodiment, inappropriate articles are evaluated regardless of the presence/absence of phrases that are prohibited from being posted (prohibited phrases). Therefore, it is possible to discover posts with inappropriate content more certainly than is conventionally possible.

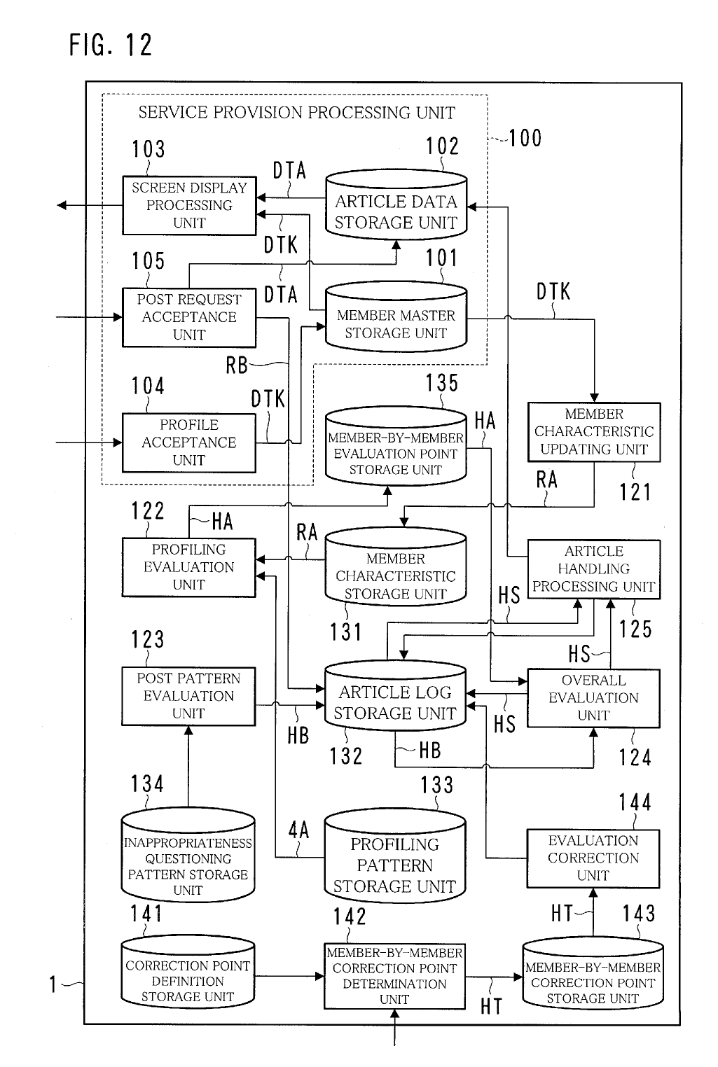

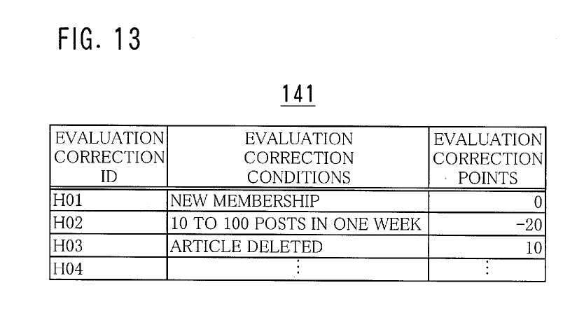

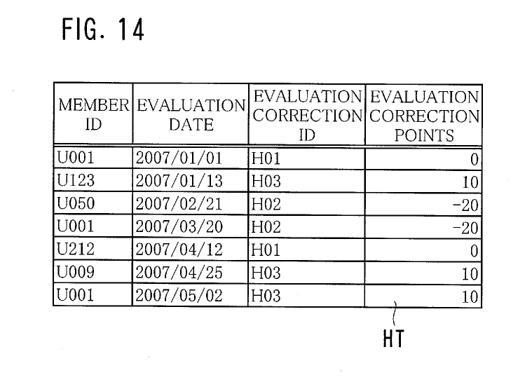

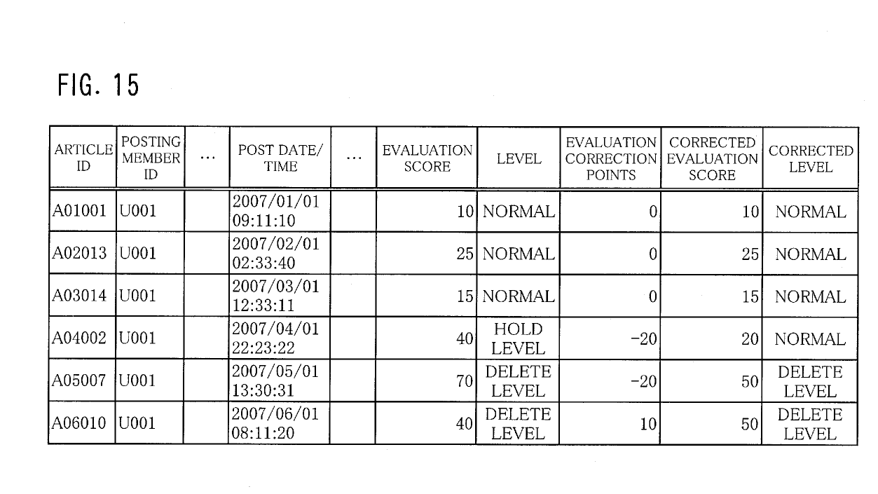

FIG. 12 illustrates a variation of the functional configuration of the SNS system 1; FIG. 13 illustrates an example of a storage format for evaluation correction points in a correction point definition storage unit 141; FIG. 14 illustrates an example of the transition of evaluation correction points HT of members; and FIG. 15 illustrates an example of the correction of an evaluation score HS.

Although in the present embodiment, the similarity between two articles is calculated by, for example, comparing the character strings that express the details of the articles, or in other words, the text data, in the case where images are included in both articles, the similarity may be calculated by comparing the images.

Furthermore, although in the present embodiment, the evaluation score HS is calculated based on the result of evaluating the inappropriateness of an article based on posting patterns and based on matching between characteristics such as the profile of the member that posted the article and profiling patterns, the evaluation score HS may be corrected based on other information as well. For example, a correction may be performed where the evaluation score HS of the article posted by the member is increased/decreased based on various issues occurring with the member. In such a case, the SNS system 1 may be configured in the following manner.

As shown in FIG. 12, the SNS system 1 may be further provided with a correction point definition storage unit 141, a member-by-member correction point determination unit 142, a member-by-member correction point storage unit 143, and an evaluation correction unit 144.

By how many points the evaluation score HS should be corrected when a certain issue occurs with the member or the member takes a certain action, or in other words, correction points for each issue or action (called “evaluation correction points” hereinafter), are stored in the correction point definition storage unit 141, as shown in FIG. 13. Negative values are defined for the evaluation correction points for issues or actions having patterns often seen in quality members, such as posting a certain amount of articles within a predetermined period, consecutively posting articles on posting destinations that are not the same, and so on. Positive values are defined for the evaluation correction points for issues or actions having patterns often seen in inappropriate members, such as posting inappropriate articles.

The member-by-member correction point determination unit 142 monitors whether or not an issue indicated in the correction point definition storage unit 141 has occurred with regards to a member and whether or not the member has taken one of the actions indicated therein. In the case where the issue has occurred or the action has been taken, evaluation correction points corresponding thereto are set for the evaluation correction points HT of the member for whom the issue occurred or who took the action. The evaluation correction points HT set in this manner are then stored in the member-by-member correction point storage unit 143 in association with the member ID of that member.

After this, in the case where a different issue has occurred or a different action has been taken, the member-by-member correction point determination unit 142 re-sets the evaluation correction points HT. The member-by-member correction point storage unit 143 then deletes the old evaluation correction points HT for that member, and then stores the re-set evaluation correction points HT in association with the member ID of that member. In this manner, the evaluation correction points HT for each member undergo transition as appropriate, as shown in FIG. 14.

The evaluation correction unit 144 corrects the evaluation score HS of the article based on the evaluation correction points HT of the member that posted the article. The overall evaluation of the article is then redone based on the corrected evaluation score HS.

To be more specific, the evaluation correction unit 144 corrects the evaluation score HS by adding the evaluation correction points HT to the evaluation score HS. Of course, in the case where the evaluation correction points HT are a negative value, the evaluation score HS decreases. If the corrected evaluation score HS is greater than or equal to the threshold TH1 but less than the threshold TH2, the article is evaluated to be at the hold level. If the corrected evaluation score HS is greater than or equal to the threshold TH2, the article is evaluated to be at the delete level. As a result, the evaluation score HS of an article posted by the member having, for example, a member ID of “U001”, is corrected as shown in FIG. 15.

Alternatively, correction may be carried out by registering phrases prohibited from being posted in a dictionary database, checking whether or not any of those phrases are included in the article, and adding a predetermined number of points to the evaluation score HS of the article in the case where such phrases are included in the article.

In the present embodiment, the likelihood that a member will post an inappropriate article is calculated based on patterns including combinations of characteristics with regards to various items. However, tendencies regarding the likelihood of a member to post an inappropriate article generally appear even when focusing on a single item at a time.

For example, even when focusing only on age, a trend in which members of a certain age post inappropriate articles more frequently than members of other ages can be seen. Alternatively, a trend in which members for whom a predetermined amount of time has not yet passed since their membership frequently post inappropriate articles can be seen. Furthermore, a trend in which members that have less than a predetermined number of friends frequently post inappropriate articles can be seen. Further still, a trend in which members that have less than a predetermined value for their profile item registration rate frequently post inappropriate articles can be seen. Finally, a trend in which members that use a free email address, or so-called “freemail”, frequently post inappropriate articles can be seen.

Accordingly, the likelihood that a member will post an inappropriate article may be calculated for each individual item, and the likelihood that the member will post an inappropriate article may then be calculated by totaling the results thereof.

The present invention can be applied not only in evaluating the inappropriateness of articles in various SNS services but also in evaluating the inappropriateness of articles on an electronic bulletin board, in emails, and so on.

In addition, many modifications to part or all of the configuration of the SNS system 1, the processing details, the processing order, the data structure, and so on can be made without deviating from the scope of the present invention.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. An inappropriate content determination apparatus comprising:
an inappropriate upload pattern storage portion that stores an inappropriate upload pattern that is a pattern of a trend seen when multiple pieces of inappropriate content are uploaded; and
an inappropriateness determination portion that determines whether or not multiple pieces of content are inappropriate by checking whether or not the inappropriate upload pattern stored in the inappropriate upload pattern storage portion is seen when the multiple pieces of content are uploaded.

2. An inappropriate content determination apparatus comprising:
an inappropriate personal pattern storage portion that stores an inappropriate personal pattern that is a pattern of a trend seen in a person who uploads inappropriate content; and
an inappropriateness determination portion that determines whether or not content uploaded by a user is inappropriate by checking whether or not a pattern of a trend seen in the user corresponds to the inappropriate personal pattern stored in the inappropriate personal pattern storage portion.

3. A content provision system for providing first content that is content uploaded by a first user via a network to a second user via the network, the system comprising:
an inappropriate upload pattern storage portion that stores an inappropriate upload pattern that is a pattern of a trend seen when multiple pieces of inappropriate content are uploaded;
an inappropriateness score allocation portion that gives multiple pieces of the first content a predetermined number of points as an inappropriateness score that is a score indicating likelihood that the multiple pieces of the first content are inappropriate, in the case where the inappropriate upload pattern stored in the inappropriate upload pattern storage portion is seen when the multiple pieces of the first content are uploaded; and
a content provision portion that provides a piece of the first content to the second user where the inappropriateness score of the piece of the first content is less than a predetermined score, and does not provide the piece of the first content to the second user where the inappropriateness score of the piece of the first content is greater than the predetermined score.

4. The content provision system according to claim 3,
wherein the inappropriate upload pattern is a pattern in which an identical person uploads no less than a predetermined number of pieces of content during an interval that is no greater than a predetermined amount of time.

5. The content provision system according to claim 3,
wherein the inappropriate upload pattern is a pattern in which an identical person uploads no less than two identical or similar pieces of content in succession.

6. A content provision system for providing first content that is content uploaded by a first user via a network to a second user via the network, the system comprising:
an inappropriate personal pattern storage portion that stores an inappropriate personal pattern that is a pattern of a trend seen in a person who uploads inappropriate content;
an inappropriateness score allocation portion that gives the first content a predetermined number of points as an inappropriateness score that is a score indicating likelihood that the first content is inappropriate where a pattern of a trend seen in the first user corresponds to the inappropriate personal pattern stored in the inappropriate personal pattern storage portion; and
a content provision portion that provides the first content to the second user where the inappropriateness score of the first content is less than a predetermined score, and does not provide the first content to the second user where the inappropriateness score of the first content is greater than the predetermined score.

7. The content provision system according to claim 6,
wherein the inappropriate personal pattern is a pattern regarding at least two of the following items: a ratio of registered profile items to a total number of profile items; a number of second users that are friends; a type of issuer of an email address used; and an amount of time that has passed since use of the content provision system commenced.

8. A content provision system for providing first content that is content uploaded by a first user via a network to a second user via the network, the system comprising:
an inappropriate personal pattern storage portion that stores an inappropriate personal pattern that is a pattern of a trend seen in a person who uploads inappropriate content;
an inappropriate upload pattern storage portion that stores an inappropriate upload pattern that is a pattern of a trend seen when multiple pieces of inappropriate content are uploaded;
a first inappropriateness score allocation portion that gives the first content a predetermined number of points as a first inappropriateness score that is a score indicating likelihood that the first content is inappropriate where a pattern of a trend seen in the first user corresponds to the inappropriate personal pattern stored in the inappropriate personal pattern storage portion;
a second inappropriateness score allocation portion that gives multiple pieces of the first content a predetermined number of points as a second inappropriateness score that is a score indicating likelihood that the multiple pieces of the first content are inappropriate where the inappropriate upload pattern stored in the inappropriate upload pattern storage portion is seen when the multiple pieces of the first content are uploaded;
a total calculation portion that calculates a total score that is a total value of the first inappropriateness score and the second inappropriateness score; and
a content provision portion that provides a piece of the first content to the second user where the total score calculated by the total calculation portion is less than a predetermined score, and does not provide the piece of the first content to the second user where the total score calculated by the total calculation portion is greater than the predetermined score.

9. The content provision system according to claim 8, further comprising:
a correction score allocation portion that gives the first content a first correction score that is a positive value where the first user has uploaded inappropriate content, and gives the first content a second correction score that is a negative value where the first user has taken a good action,
wherein the total calculation portion calculates, as the total score, a total value of the first inappropriateness score, the second inappropriateness score, and one of the first correction score and the second correction score given by the correction score allocation portion, instead of the total value of the first inappropriateness score and the second inappropriateness score.

10. An inappropriate content determination method, comprising:
causing an inappropriate upload pattern storage portion to store in advance an inappropriate upload pattern that is a pattern of a trend seen when multiple pieces of inappropriate content are uploaded; and
determining whether or not multiple pieces of content are inappropriate by causing a computer to check whether or not the inappropriate upload pattern stored in the inappropriate upload pattern storage portion is seen when the multiple pieces of content are uploaded.

11. An inappropriate content determination method, comprising:
causing an inappropriate personal pattern storage portion to store in advance an inappropriate personal pattern that is a pattern of a trend seen in a person who uploads inappropriate content; and
determining whether or not content uploaded by a user is inappropriate by causing a computer to check whether or not a pattern of a trend seen in the user corresponds to the inappropriate personal pattern stored in the inappropriate personal pattern storage portion.

12. A content provision method for providing first content that is content uploaded by a first user via a network to a second user via the network, the method comprising:
causing an inappropriate upload pattern storage portion to store in advance an inappropriate upload pattern that is a pattern of a trend seen when multiple pieces of inappropriate content are uploaded; and
causing a computer to:
execute a process for giving multiple pieces of the first content a predetermined number of points as an inappropriateness score that is a score indicating likelihood that the multiple pieces of the first content are inappropriate where the inappropriate upload pattern stored in the inappropriate upload pattern storage portion is seen when the multiple pieces of the first content are uploaded; and
execute a process for providing a piece of the first content to the second user where the inappropriateness score of the piece of the first content is less than a predetermined score, and not providing the piece of the first content to the second user where the inappropriateness score of the piece of the first content is greater than the predetermined score.

13. A content provision method for providing first content that is content uploaded by a first user via a network to a second user via the network, the method comprising:
causing an inappropriate personal pattern storage portion to store in advance an inappropriate personal pattern that is a pattern of a trend seen in a person who uploads inappropriate content; and
causing a computer to:
execute a process for giving the first content a predetermined number of points as an inappropriateness score that is a score indicating likelihood that the first content is inappropriate where a pattern of a trend seen in the first user corresponds to the inappropriate personal pattern stored in the inappropriate personal pattern storage portion; and
execute a process for providing the first content to the second user where the inappropriateness score of the first content is less than a predetermined score, and not providing the first content to the second user where the inappropriateness score of the first content is greater than the predetermined score.

14. A computer-readable recording medium storing a computer program used in a computer that provides first content that is content uploaded by a first user via a network to a second user via the network and that can access an inappropriate upload pattern storage portion that stores an inappropriate upload pattern that is a pattern of a trend seen when multiple pieces of inappropriate content are uploaded, the program causing the computer to:
execute a process for giving multiple pieces of first content a predetermined number of points as an inappropriateness score that is a score indicating likelihood that the multiple pieces of first content are inappropriate where the inappropriate upload pattern stored in the inappropriate upload pattern storage portion is seen when the multiple pieces of first content are uploaded; and
execute a process for providing the first content to the second user where the inappropriateness score of the first content is less than a predetermined score, and not providing the first content to the second user where the inappropriateness score of the first content is greater than the predetermined score.
